(19) United States
(12) Patent Application Publication
(10) Pub. No.: US 2024/0029620 A1
(43) Pub. Date: Jan. 25, 2024

(54) DISPLAY POWER-SUPPLYING MODULE AND DISPLAY DEVICE

(71) Applicant: TCL CHINA STAR OPTOELECTRONICS TECHNOLOGY CO., LTD., Shenzhen, Guangdong (CN)

(72) Inventor: Wenfang Li, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/615,086

(22) PCT Filed: Nov. 2, 2021
(86) PCT No.: PCT/CN2021/128109

§ 371 Date: Apr. 27, 2023

(30) Foreign Application Priority Data
Oct. 18, 2021 (CN) 202111211381.4

(51) Int. Cl. G09G 3/20

(52) U.S. Cl. CPC G09G 3/2092; G09G 2310/08; G09G 2330/021

(57) ABSTRACT

A display power-supplying module and a display device. The display power-supplying module includes a timing controller configured to generate a load signal according to a picture signal; a power supply electrically connected to the timing controller, wherein the power supply is configured to have a plurality of power-supplying channels, and at least one of the plurality of power-supplying channels is enabled to transmit electrical signals according to the load signal; and an integration circuit electrically connected to the plurality of power-supplying channels of the power supply, wherein the integration circuit is configured to generate an analog positive power source according to the electrical signals transmitted by the at least one power-supplying channel that is enabled.

### FIELD OF INVENTION

The present disclosure relates to the technical field of display, and specifically to a display power-supplying module and a display device.

### BACKGROUND OF INVENTION

As users' requirements for display quality increase, a resolution of a display device becomes higher and higher. As the resolution becomes higher, currents in different control loops also increase. Correspondingly, operating temperatures of integration circuits in different loops also become higher and higher, and specifications of peripheral devices are correspondingly improved.

For example, in a liquid crystal display device, a load level can be judged according to a content of a display picture. Although there have been some distributed circuit designs in the past, a circuit operation has not been adapted to different load levels, resulting in low efficiency of integration circuits under light-load conditions, which still needs to be improved.

### SUMMARY OF INVENTION

The present disclosure provides a display power-supplying module and a display device, which are used to improve efficiency of integration circuits in the display device in the prior art.

To solve the above problem, a first aspect of the present disclosure provides a display power-supplying module, which includes: a timing controller configured to generate a load signal according to a picture signal; a power supply electrically connected to the timing controller, wherein the power supply is configured to have a plurality of power-supplying channels, and at least one of the plurality of power-supplying channels is enabled to transmit electrical signals according to the load signal; and an integration circuit electrically connected to the plurality of power-supplying channels of the power supply, wherein the integration circuit is configured to generate an analog positive power source according to the electrical signals transmitted by the at least one power-supplying channel that is enabled; wherein the power supply transmits at least one pulse width modulation signal to the at least one power-supplying channel that is enabled according to the load signal; and the integration circuit includes a plurality of signal processing parts, and each of the plurality of signal processing parts is electrically connected between one of the plurality of power-supplying channels and a power output port that outputs the analog positive power source.

According to an embodiment of the present disclosure, the power supply includes a controller, and the controller generates the at least one pulse width modulation signal according to the load signal and transmits the at least one pulse width modulated signal to the at least one power-supplying channel that is enabled.

According to an embodiment of the present disclosure, the plurality of power-supplying channels are two power-supplying channels.

According to an embodiment of the present disclosure, the timing controller judges whether a present picture is a heavy-load picture according to the picture signal, if a judgment is yes, the load signal is a high-level signal, and if the judgment is no, the load signal is a low-level signal.

According to an embodiment of the present disclosure, the power supply enables the two power-supplying channels in response to the load signal being the high-level signal; and the power supply enables one of the two power-supplying channels in response to the load signal being the low-level signal.

According to an embodiment of the present disclosure, each of the signal processing parts includes a switching element, an inductor, a resistor, a rectifying element, and a capacitor, wherein the switching element is electrically connected to the power-supplying channel, the resistor is electrically connected between the switching element and a ground terminal, the inductor is electrically connected between the switching element and a positive power terminal, one end of the rectifying element is electrically connected to the switching element and the inductor, the other end of the rectifying element is electrically connected to the power output port, and the capacitor is electrically connected between the power output port and the ground terminal.

According to an embodiment of the present disclosure, the power supply is configured to form a boost integrated circuit.

To solve the above problem, a second aspect of the present disclosure provides a display power-supplying module, including: a timing controller configured to generate a load signal according to a picture signal; a power supply electrically connected to the timing controller, wherein the power supply is configured to have a plurality of power-supplying channels, and at least one of the plurality of power-supplying channels is enabled to transmit electrical signals according to the load signal; and an integration circuit electrically connected to the plurality of power-supplying channels of the power supply, wherein the integration circuit is configured to generate an analog positive power source according to the electrical signals transmitted by the at least one power-supplying channel that is enabled.

According to an embodiment, the power supply transmits at least one pulse width modulation signal to the at least one power-supplying channel that is enabled according to the load signal

According to an embodiment, the power supply includes a controller, and the controller generates the at least one pulse width modulation signal according to the load signal and transmits the at least one pulse width modulated signal to the at least one power-supplying channel that is enabled.

According to an embodiment, the plurality of power-supplying channels are two power-supplying channels.

According to an embodiment, the timing controller judges whether a present picture is a heavy-load picture according to the picture signal, if a judgment is yes, the load signal is a high-level signal, and if the judgment is no, the load signal is a low-level signal.

According to an embodiment, the power supply enables the two power-supplying channels in response to the load signal being the high-level signal; and the power supply enables one of the two power-supplying channels in response to the load signal being the low-level signal.

According to an embodiment, the integration circuit includes a plurality of signal processing parts, and each of the plurality of signal processing parts is electrically connected between one of the plurality of power-supplying channels and a power output port that outputs the analog positive power source.

According to an embodiment, each of the signal processing parts comprises a switching element, an inductor, a resistor, a rectifying element, and a capacitor, wherein the switching element is electrically connected to the power-supplying channel, the resistor is electrically connected between the switching element and a ground terminal, the inductor is electrically connected between the switching element and a positive power terminal, one end of the rectifying element is electrically connected to the switching element and the inductor, the other end of the rectifying element is electrically connected to the power output port, and the capacitor is electrically connected between the power output port and the ground terminal.

According to an embodiment, the power supply is configured to form a boost integrated circuit.

To solve the above problem, a third aspect of the present disclosure provides a display device including the display power-supplying module as described above.

In the display power-supplying module and the display device of the present disclosure, the load signal is generated by the timing controller according to the picture signal; the power supply device enables at least one of the plurality of power-supplying channels for transmitting electrical signals according to the load signal; and the integration circuit generates the analog positive power source according to the electrical signals transmitted by the at least one power-supplying channel that is enabled. Therefore, more power-supplying channels are enabled on a heavy-load picture to transmit electrical signals, and less power-supplying channels are enabled on a light-load picture to transmit electrical signals. In the case of the light-load picture, only one power-supplying channel is enabled, which can greatly reduce the thermal energy generated by the transmission of electrical signals, thereby not only reducing the temperature of peripheral devices of the power supply but also improving the operating efficiency of a circuit in a case of the light-load picture.

### BRIEF DESCRIPTION OF DRAWINGS

In order to explain the technical solutions in the embodiments of the present disclosure more clearly, the following will briefly introduce the drawings needed in the description of the embodiments. Obviously, the drawings in the following description are only some embodiments of the present disclosure. For those skilled in the art, without creative work, other drawings can be obtained based on these drawings.

FIG. 1 is a schematic circuit diagram of a display power-supplying module according to an embodiment of the present disclosure;

FIG. 2 is a schematic diagram of signals for enabling two power-supplying channels when a heavy-load picture is shown according to an embodiment of the present disclosure;

FIG. 3 is a schematic diagram of a signal for enabling a single power-supplying channel when a light-load picture is shown according to an embodiment of the present disclosure;

FIG. 4 shows a schematic circuit diagram of a display power-supplying module serving as a comparison example.

### DETAILED DESCRIPTION OF PREFERRED EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those skilled in the art without creative work shall fall within the protection scope of the present disclosure.

In the description herein, it should be understood that the terms such as “central,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” and “counterclockwise” indicating a directional or positional relationship are based on orientation or positional relationship shown in the drawings, and are only for the convenience of describing the present disclosure and simplifying the description, and do not indicate or imply that the device or element referred to has a specific orientation and is constructed and operated in a specific orientation, and therefore it cannot be understood as a limitation to the present disclosure.

In the description herein, it should be understood that the terms “first” and “second” are only used for descriptive purposes, and cannot be understood as indicating or implying relative importance or implicitly indicating the number of indicated technical features. Therefore, the features defined with “first” and “second” may explicitly or implicitly include one or more of the features. In the description of the present disclosure, “plurality” means two or more, unless otherwise specifically defined.

Many different embodiments or examples are provided herein to realize the different structures of the present disclosure. In order to simplify the disclosure of the present disclosure, the components and settings of specific examples are described below. Certainly, they are only examples, and the purpose is not to limit the present disclosure. In addition, the present disclosure may repeat reference numerals and/or reference letters in different examples, and this repetition is for the purpose of simplification and clarity and itself does not indicate the relationship between the various embodiments and/or settings discussed. In addition, examples of various specific processes and materials are provided herein, but those of ordinary skill in the art may be aware of the application of other processes and/or the use of other materials.

In the liquid crystal display device, a load level can be judged based on the content of the display picture. Examples are described as follows, but are not limited to the description here.

A first aspect of the present disclosure provides a display power-supplying module. The display power-supplying module can be applied to a high-resolution liquid crystal display device, such as a liquid crystal display device with an 8K resolution, but is not limited to the description here.

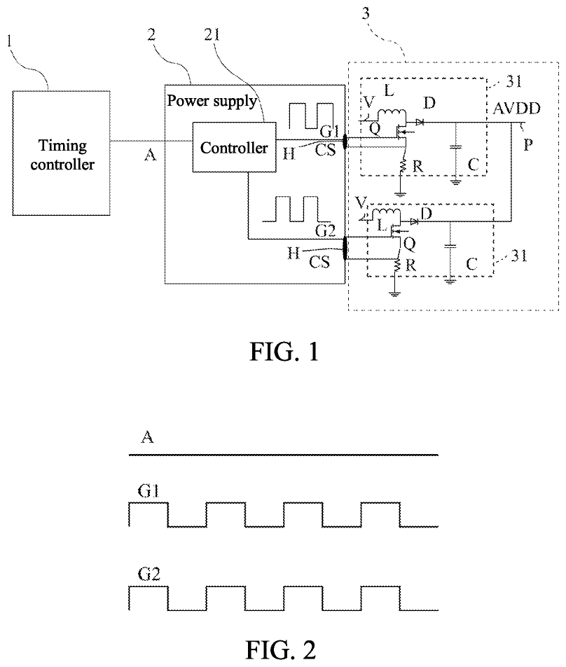

As shown in FIG. 1, the display power-supplying module includes: a timing controller 1, an electric supply 2, and an integration circuit 3. The timing controller 1 is electrically connected to the electric supply 2, and the electric supply 2 is electrically connected to the integration circuit 3 for outputting direct current power in response to display pictures with different load levels, which can be supplied to an internal circuit operation of the liquid crystal display device.

The following examples illustrate implementations of the display power-supplying module but are not limited to the description here.

For example, as shown in FIG. 1, the timing controller 1 may be configured to generate a load signal A according to a picture signal. For example, the timing controller 1 can receive a picture signal detected by other detection devices (such as an embedded system on a chip) to know the load level of the present picture. For example, the content of a non-pure color picture is more complicated and can be regarded as a heavy-load picture, and the content of a pure color or grayscale picture is relatively simple and can be regarded as a light-load picture. The timing controller 1 can generate the load signal A according to the picture signal to indicate different loading levels of the display picture.

It should be understood that a number of the load level can be, for example, two or more. Correspondingly, a number of the plurality of power-supplying channels H can also be, for example, two or more. The load signal A can be, for example, configured as a signal with multiple variations of a single feature (such as multiple levels or multiple pulse widths, etc.) or a combination of multiple features to facilitate identification of multiple load levels.

As shown in FIG. 1, the power supply 2 is electrically connected to the timing controller 1. The power supply 2 can be configured to have a plurality of power-supplying channels H, and to enable at least one of the plurality of power-supplying channels according to the load signal A to transmit electrical signals. For example, the power supply 2 can transmit at least one pulse width modulation signal to the at least one power-supplying channel H that is enabled according to the load signal A. For example, the power supply 2 includes a controller 21, the controller 21 can generate at least one pulse width modulation (PWM) signal according to the load signal A, and transmit the at least one pulse width modulation signal to the at least one power-supplying channel H that is enabled. For example, the power supply 2 can also be configured as a boost integrated circuit (Boost IC). As shown in FIG. 1, the integration circuit 3 is electrically connected to the plurality of power-supplying channels H of the power supply 2. The integration circuit 3 is configured to generate an analog positive power AVDD according to the power delivered by the power supply channel H that is enabled. For example, the integration circuit 3 includes a plurality of signal processing parts 31, and each of the plurality of signal processing parts 31 is electrically connected between one of the plurality of power-supplying channels H and a power output port P, wherein the power output port P outputs the analog positive power AVDD.

Optionally, as shown in FIG. 1, in order to simplify the description, the plurality of power-supplying channels H are described by taking two power-supplying channels H as an example, that is, they are divided into two phases but are not limited to the description here, and the number of the plurality of power-supplying channels H can be fine-tuned according to actual requirements.

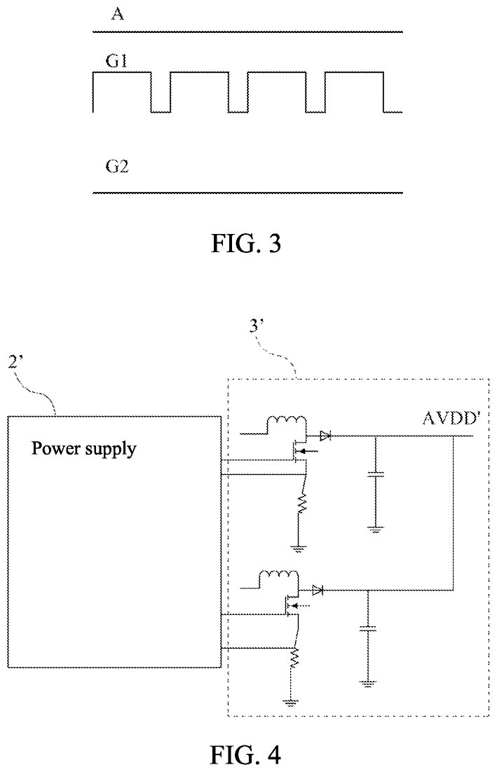

For example, as shown in FIG. 1, the timing controller 1 may judge whether the present picture is a heavy-load picture according to the picture signal. If a judgment is yes, it means that the present picture is the heavy-load picture, and the load signal A (shown in FIG. 2) is a high-level signal. If the judgment is no, it means that the present picture is a light-loaded picture, and the load signal A (shown in FIG. 3) is a low-level signal.

As shown in FIGS. 1 and 2, the power supply 2 can enable the two power-supplying channels H in response to the load signal A being the high-level signal, so that the two power-supplying channels H that are enabled can transmit electrical signals G1 and G2. For example, the electrical signals G1 and G2 are pulse width modulated signals, respectively. In addition, as shown in FIGS. 1 and 3, the electrical supply 2 can enable one (e.g., the upper power-supplying channel H shown in FIG. 1) of the two power-supplying channels H in response to the load signal A being the low-level signal, so that the one enabled power-supplying channel H can transmit the electrical signal (such as G1). For example, the electricity signal G1 is a pulse width modulated signal. At this time, the electrical signal G2 can be a low-level signal. Optionally, each power-supplying channel H can also transmit a current detection signal CS to indicate whether the power-supplying channel H is enabled and transmits a validity indicator of the pulse width modulation signal. For example, the current detection signal CS is at a high level to indicate that the power-supplying channel H is enabled for transmitting the pulse width modulation signal, and the current detection signal CS is at a low level to indicate that the power-supplying channel H is not enabled for transmitting the pulse width modulation signal.

As shown in FIG. 1, the integration circuit 3 includes two signal processing parts 31, wherein one of the two signal processing parts 31 is electrically connected between one of the two power-supplying channels H and the power output port P, the other of the two signal processing parts 31 is electrically connected between the other of the two power-supplying channels H and the power output port P. The power output port P can output the analog positive power.

As shown in FIG. 1, the signal processing part 31 may include a switching element (such as an N-channel enhancement type metal oxide semiconductor transistor, MOSFET) Q, an inductor L, a resistor R, a rectifying element (such as a diode) D, and a capacitor C, wherein a control terminal (such as a gate) of the switching element Q is electrically connected to the power-supplying channel H, the resistor R is electrically connected between a first terminal (such as a source) of the switching element Q and a ground terminal, the inductor L is electrically connected between a second terminal (such as a drain) of the switching element Q and a positive power terminal (such as inputting a positive voltage of 12 volts) V, one end of the rectifying element D is electrically connected to the second terminal of the switching element Q and the inductor L, the other end of the rectifying element D is electrically connected to the power output port P, the capacitor C is electrically connected between the power output port P and the ground terminal, and the power output port P outputs the analog positive power AVDD, so as to be suitable for different load pictures.

In this example, as shown in FIG. 1, the inductor L of each of the two signal processing parts 31 can input a positive voltage of 12 volts via the positive power terminal V. The control terminal of the switching element Q of a first signal processing part 31 can input the electrical signal G1 via a first power supply channel H (e.g., an upper power supply channel H), and the first terminal of the switching element Q of the first signal processing part 31 can input the current detection signal CS via the first power supply channel H. The control terminal of the switching element Q of a second signal processing part 31 can be connected to the electrical signal G2 via the second power supply channel H (e.g., a lower power supply channel H), and the first terminal of the switching element Q of the second signal processing part 31 can input the current detection signal CS via the second power supply channel H, but is not limited to the description here.

Optionally, in an embodiment, as shown in FIG. 1, the power supply 2 transmits at least one pulse width modulation signal to the at least one power-supplying channel that is enabled according to the load signal A. Therefore, the pulse width modulation signal transmitted through the enabled power-supplying channel can be used as a power source for the subsequent generation of the analog positive power source.

The following examples illustrate some embodiments of the display power-supplying module, but are not limited to the description here.

Optionally, in an embodiment, as shown in FIG. 1, the power supply 2 includes a controller 21, wherein the controller 21 transmits the at least one pulse width modulation signal according to the load signal A, and the at least one pulse width modulation signal is transmitted to the at least one power-supplying channel H that is enabled. Therefore, by a control logic built in the controller, after the controller receives the load signal A, an appropriate number of pulse width modulation signals can be generated according to picture load information represented by the load signal A to serve as a source of subsequent electrical signals for generating the analog positive power source.

Optionally, in an embodiment, as shown in FIG. 1, the plurality of power-supplying channels H are two power-supplying channels H. Therefore, corresponding to the two load modes in the load signal A, such as a heavy-load picture or a light-load picture, the two power-supplying channels can provide pulse width modulation signals in a distributed manner, and the circuit can be operated by means of distributed signal transmission. The temperature is dispersed to the peripheral devices of different power-supplying channels to avoid reducing operation efficiency of the circuit.

Optionally, in an embodiment, as shown in FIG. 1, the timing controller 1 judges whether a present picture is a heavy-load picture according to the picture signal, and if a judgment is yes, the load signal A is configured to a high-level signal, if the judgment is no, the load signal A is configured to a low-level signal. Therefore, the two-level characteristics of the single load signal A can be judged by the timing controller 1 to indicate two load modes, such as the heavy-load picture or the light-load picture, so as to facilitate the subsequent generation of a corresponding number of power sources.

Optionally, in an embodiment, as shown in FIG. 1, the power supply 2 enables the two power-supplying channels H in response to the load signal A being the high-level signal; and the power supply 2 enables one of the two power-supplying channels H in response to the load signal A being the low-level signal. Therefore, when the load signal A is the high-level signal, it means that the present picture is the heavy-load picture, and the two power-supplying channels are enabled, which can reduce the temperature of the peripheral components of the power supply; when the load signal A is the low-level signal, it means that the present picture is the light-load picture, and only one of the two power-supplying channels is enabled, for example, only the first power-supplying channel is enabled, which can greatly reduce the transmission of electrical signals, thereby not only reducing the heat energy generated by the temperature of the peripheral devices of the power supply but also improving the operating efficiency of the circuit under the condition of the light-load picture.

Optionally, in an embodiment, as shown in FIG. 1, the integration circuit 3 includes a plurality of signal processing parts 31, and each of the plurality of signal processing parts 31 is electrically connected between one of the power-supplying channels H and a power output port P, wherein the power output port P outputs the analog positive power AVDD. Therefore, the integration circuit is provided with one or more signal processing parts corresponding to a number of one or more power-supplying channels, so as to use the power-supplying channels to transmit corresponding electrical signals for generating the analog positive power source.

Optionally, in an embodiment, as shown in FIG. 1, the signal processing part 31 includes a switching element Q, an inductor L, a resistor R, a rectifying element D, and a capacitor C. The switching element Q is electrically connected to the power-supplying channel H. The resistor R is electrically connected between the switching element Q and a ground terminal. The inductor L is electrically connected between the switching element Q and a positive power terminal V. One end of the rectifying element D is electrically connected to the switching element Q and the inductor L, and the other end of the rectifying element D is electrically connected to the power output port P. The capacitor C is electrically connected between the power output port P and the ground terminal. Thus, by the power-supplying channel electrically connected to the switching element, the resistor electrically connected to the switching element, the inductor electrically connected to the switching element, and the rectifying element electrically connected to the switching element and the capacitor, the power output port can be used to output the analog positive power source with appropriate electrical energy to serve as a power source for the display device to display pictures with different load levels.

Optionally, in an embodiment, as shown in FIG. 1, the power supply 2 is configured to form a boost integrated circuit. Therefore, the power supply can be used to receive the load signal A to enable an appropriate number of power-supplying channels, and to generate a signal in an appropriate form for transmission, so as to be used as a basis for the subsequent generation of the analog positive power source.

In the embodiment shown in FIG. 1, the display power-supplying module can be achieved by the timing controller 1 generates the load signal A according to the picture signal, and the power supply 2 enables at least one of the multiple power supply channels according to the load signal A for transmitting electrical signals; and the integration circuit 3 generates the analog positive power source according to the electrical signals transmitted by the at least one power-supplying channel that is enabled.

Therefore, more power-supplying channels are enabled for the heavy-load picture to transmit electrical signals, and fewer power-supplying channels are enabled for the light-load picture to transmit electrical signals. In the case of the light-load picture, only one power-supplying channel is enabled, which can greatly reduce the heat energy generated by the transmission of electrical signals, thereby not only reducing the temperature of the peripheral components of the power supply but also improving the operating efficiency of the circuit under the light-load picture situation.

FIG. 4 is a schematic circuit diagram of a display power-supplying module shown as a comparison example. In the comparison example shown in FIG. 4, another display power-supplying module includes a power supply 2′ and an integration circuit 3′. The power supply 2′ does not selectively enable power-supplying channels to transmit electrical signals for different load modes. Regardless of whether a present picture is a heavy-load picture or a light-load picture, the integration circuit 3′ simultaneously receives two phases of electrical signals from the power supply 2′ to generate another analog positive power source AVDD′. The analog positive power source AVDD′ is the same for displaying the heavy-load picture or the light-load picture. As a result, the operating temperature of a circuit under the light-load picture cannot be lowered to derivate the low operational efficiency of the circuit.

Compared with the comparison example without a load signal generated by a timing controller to enable at least one of the plurality of power-supplying channels, the display power-supplying module of the embodiments of the present disclosure generates the load signal by the timing controller to enable at least one of the plurality of power-supplying channels for transmitting electrical signals to generate the analog positive power source. The analog positive power source is generated by a different number of electrical signals for the heavy-load picture or the light-load picture. In the case of the light-load picture, only one power-supplying channel is enabled, which can greatly reduce the thermal energy generated by the electric signal transmission, thereby not only reducing the temperature of the peripheral devices of the electric supply but also improving the operating efficiency of the circuit under the condition of the light-load picture.

In addition, a second aspect of the present disclosure provides a display device, such as a liquid crystal display device. The display device includes the display power-supplying module as described above.

According to the display power-supplying module and the display device of the above-mentioned embodiment of the present disclosure, the load signal is generated by the timing controller according to the picture signal; the power supply device enables at least one of the plurality of power-supplying channels for transmitting electrical signals according to the load signal; and the integration circuit generates the analog positive power source according to the electrical signals transmitted by the at least one power-supplying channel that is enabled. Therefore, more power-supplying channels are enabled on a heavy-load picture to transmit electrical signals, and less power-supplying channels are enabled on a light-load picture to transmit electrical signals. In the case of the light-load picture, only one power-supplying channel is enabled, which can greatly reduce the thermal energy generated by the transmission of electrical signals, thereby not only reducing the temperature of peripheral devices of the power supply but also improving the operating efficiency of a circuit in a case of the light-load picture.

The embodiments of the present disclosure are described in detail above, and specific examples are used herein to illustrate the principles and implementation of the present disclosure. The descriptions of the above embodiments are only used to help understand the technical solutions and core ideas of the present disclosure. Those skilled in the art should understand that they can still modify the technical solutions recorded in the previous embodiments or equivalently replace some technical features. However, these modifications or replacements do not cause the essence of the corresponding technical solutions to deviate from the scope of the technical solutions of the embodiments of the present disclosure.

What is claimed is:

1. A display power-supplying module, comprising:
a timing controller configured to generate a load signal according to a picture signal;
a power supply electrically connected to the timing controller, wherein the power supply is configured to have a plurality of power-supplying channels, and at least one of the plurality of power-supplying channels is enabled to transmit electrical signals according to the load signal; and
an integration circuit electrically connected to the plurality of power-supplying channels of the power supply, wherein the integration circuit is configured to generate an analog positive power source according to the electrical signals transmitted by the at least one power-supplying channel that is enabled;
wherein the power supply transmits at least one pulse width modulation signal to the at least one power-supplying channel that is enabled according to the load signal; and the integration circuit comprises a plurality of signal processing parts, and each of the plurality of signal processing parts is electrically connected between one of the plurality of power-supplying channels and a power output port that outputs the analog positive power source.

2. The display power-supplying module as claimed in claim 1, wherein the power supply comprises a controller, and the controller generates the at least one pulse width modulation signal according to the load signal and transmits the at least one pulse width modulated signal to the at least one power-supplying channel that is enabled.

3. The display power-supplying module as claimed in claim 1, wherein the plurality of power-supplying channels are two power-supplying channels.

4. The display power-supplying module as claimed in claim 3, wherein the timing controller judges whether a present picture is a heavy-load picture according to the picture signal, if a judgment is yes, the load signal is a high-level signal, and if the judgment is no, the load signal is a low-level signal.

5. The display power-supplying module as claimed in claim 4, wherein the power supply enables the two power-supplying channels in response to the load signal being the high-level signal; and the power supply enables one of the two power-supplying channels in response to the load signal being the low-level signal.

6. The display power-supplying module as claimed in claim 1, wherein each of the signal processing parts comprises a switching element, an inductor, a resistor, a rectifying element, and a capacitor, wherein the switching element is electrically connected to the power-supplying channel, the resistor is electrically connected between the switching element and a ground terminal, the inductor is electrically connected between the switching element and a positive power terminal, one end of the rectifying element is electrically connected to the switching element and the inductor, the other end of the rectifying element is electrically connected to the power output port, and the capacitor is electrically connected between the power output port and the ground terminal.

7. The display power-supplying module as claimed in claim 1, wherein the power supply is configured to form a boost integrated circuit.

8. A display power-supplying module, comprising:
a timing controller configured to generate a load signal according to a picture signal;
a power supply electrically connected to the timing controller, wherein the power supply is configured to have a plurality of power-supplying channels, and at least one of the plurality of power-supplying channels is enabled to transmit electrical signals according to the load signal; and
an integration circuit electrically connected to the plurality of power-supplying channels of the power supply, wherein the integration circuit is configured to generate an analog positive power source according to the electrical signals transmitted by the at least one power-supplying channel that is enabled.

9. The display power-supplying module as claimed in claim 8, wherein the power supply transmits at least one pulse width modulation signal to the at least one power-supplying channel that is enabled according to the load signal.

10. The display power-supplying module as claimed in claim 9, wherein the power supply comprises a controller, and the controller generates the at least one pulse width modulation signal according to the load signal and transmits the at least one pulse width modulated signal to the at least one power-supplying channel that is enabled.

11. The display power-supplying module as claimed in claim 8, wherein the plurality of power-supplying channels are two power-supplying channels.

12. The display power-supplying module as claimed in claim 11, wherein the timing controller judges whether a present picture is a heavy-load picture according to the picture signal, if a judgment is yes, the load signal is a high-level signal, and if the judgment is no, the load signal is a low-level signal.

13. The display power-supplying module as claimed in claim 12, wherein the power supply enables the two power-supplying channels in response to the load signal being the high-level signal; and the power supply enables one of the two power-supplying channels in response to the load signal being the low-level signal.

14. The display power-supplying module as claimed in claim 8, wherein the integration circuit comprises a plurality of signal processing parts, and each of the plurality of signal processing parts is electrically connected between one of the plurality of power-supplying channels and a power output port that outputs the analog positive power source.

15. The display power-supplying module as claimed in claim 14, wherein each of the signal processing parts comprises a switching element, an inductor, a resistor, a rectifying element, and a capacitor, wherein the switching element is electrically connected to the power-supplying channel, the resistor is electrically connected between the switching element and a ground terminal, the inductor is electrically connected between the switching element and a positive power terminal, one end of the rectifying element is electrically connected to the switching element and the inductor, the other end of the rectifying element is electrically connected to the power output port, and the capacitor is electrically connected between the power output port and the ground terminal.

16. The display power-supplying module as claimed in claim 8, wherein the power supply is configured to form a boost integrated circuit.

17. A display device comprising a display power-supplying module, wherein the display power-supplying module comprises:
a timing controller configured to generate a load signal according to a picture signal;
a power supply electrically connected to the timing controller, wherein the power supply is configured to have a plurality of power-supplying channels, and at least one of the plurality of power-supplying channels is enabled to transmit electrical signals according to the load signal; and
an integration circuit electrically connected to the plurality of power-supplying channels of the power supply, wherein the integration circuit is configured to generate an analog positive power source according to the electrical signals transmitted by the at least one power-supplying channel that is enabled.
